(19) United States
(12) Patent Application Publication
(10) Pub. No.: US 2018/0238426 A1
(43) Pub. Date: Aug. 23, 2018

(54) RELEASE MECHANISM INCORPORATED LINEAR ACTUATOR

(71) Applicant: MOTECK ELECTRIC CORP., New Taipei (TW)

(72) Inventor: Chih-Li HUNG, New Taipei (TW)

(21) Appl. No.: 15/871,345

(22) Filed: Jan. 15, 2018

(30) Foreign Application Priority Data
Feb. 20, 2017 (TW) 106202430

(51) Int. Cl. F16H 25/24; F16H 57/039

(52) U.S. Cl. CPC F16H 25/2454; F16H 2025/209; F16H 57/039

(57) ABSTRACT

A release mechanism incorporated linear actuator includes an actuator body and a release mechanism connected between a retractable tube set and a coupling. An adapter socket connected to the retractable tube set, a locating socket movably coupled to the adapter socket and connected to the coupling, a brake spring mounted around the adapter socket, a tightening sleeve sleeved onto the locating socket and the brake spring and connected to the locating socket, and a rotary knob attached onto the tightening sleeve. The brake spring is disposed in friction engagement with a surface of the tightening sleeve, having one end piece positioned in the adapter socket and an opposite end piece positioned in the rotary knob. When the rotary knob is rotated to move the opposite end piece, the brake spring is forced to reduce diameter and to wrap about adapter socket, releasing friction engagement between brake spring and tightening sleeve.

This application claims the priority benefit of Taiwan patent application number 106202430, filed on Feb. 20, 2017.

### BACKGROUND OF THE INVENTION

### 1. Field of the Invention

The present invention relates to linear actuator technology and more particularly, to a release mechanism incorporated linear actuator, which comprises a release mechanism coupled between a retractable tube set of an actuator body and a coupling, allowing rotation of a rotary knob of the release mechanism to disengage a brake spring from a tightening sleeve for manual operation of the retractable tube set.

### 2. Description of the Related Art

Many different types of linear actuators with different mechanical and transmission designs are known for use in electric beds, massage chairs, fitness machines, rehabilitation equipment, and many other electrically controllable displacement devices for elevation or angular position adjustment. During the operation of the motor in a conventional linear actuator, a linked retractable tube is moved between an extended position and a received position to achieve elevation or angular position adjustment. In the event of a power outage or an emergency, the user may operate the clutch mechanism or device inside the actuator to release it, allowing the retractable tube set-connected lifting or tilting mechanism to be quickly descended. However, when the clutch mechanism or device is released, the actuator will drop suddenly, making the user feel uncomfortable or causing an impact or component damage. When this problem occurs, it will be dangerous.

FIG. 12 illustrates a prior art linear actuator design, which comprises an actuator body D, an extension sleeve D1 coupled and linearly movable relative to a screw rod of the actuator body D, a first socket A connected to the extension sleeve D1, a second socket B fastened to a connector D2 of an external apparatus and movable coupled to the first socket A, and a clutch module C. The clutch module C comprises a barrel C1 connected to the second socket B, a first operating ring C2 and a second operating ring C3 coupled to the barrel C1. When the second operating ring C3 is not released by the user, two opposing internal protrusions C11 of the barrel C1 are engaged in respective recessed portions D11 of the extension sleeve D1, allowing movement of the connector D2 of the external apparatus with the extension sleeve D to adjust the elevation or angle.

When the clutch module C is released, the internal protrusions C11 of the barrel C1 are disengaged from the respective recessed portions D11 of the extension sleeve D1, enabling the extension sleeve D1 to be moved back along the screw rod by the external apparatus, and thus, the external apparatus can be quickly lowered. However, if the external apparatus carries a heavy person or bears a heavy load, it will force the extension sleeve D1 to retract suddenly, frightening the user and affecting the user's mood, and leading to a security problem or component damage. Thus, the user's life or property will suffer serious loss or injury. An improvement in this regard is necessary.

### SUMMARY OF THE INVENTION

The present invention has been accomplished under the circumstances in view. It is one object of the present invention to provide a release mechanism incorporated linear actuator, which comprises an actuator body and a release mechanism. The release mechanism is connected between a retractable tube set and a coupling of the actuator body, comprising an adapter socket connected to the retractable tube set, a locating socket movably coupled to the adapter socket and connected to the coupling, a brake spring mounted around the adapter socket, a tightening sleeve sleeved onto the locating socket and the brake spring and connected to the locating socket, and a rotary knob attached onto the tightening sleeve. The brake spring is disposed in friction engagement with an inner surface of the tightening sleeve, having one end piece thereof positioned in the adapter socket and an opposite end piece thereof positioned in the rotary knob. When the user rotates the rotary knob to move the opposite end piece, the brake spring is forced to reduce the diameter and to wrap about the adapter socket, releasing friction engagement between the brake spring and the tightening sleeve and allowing manual operation of the retractable tube set upon power failure or mechanical failure. Thus, the invention greatly enhances operational safety.

Further, the actuator body of the release mechanism incorporated linear actuator can be installed in a link or bracket seat of an external apparatus (such as electric bed, massage chair, fitness or rehabilitation machine), lifter or any other equipment. In installation, the connection rod of the holder block and the coupling of the actuator body are respectively pivotally connected to the link or bracket seat of the external apparatus by a screw bolts or pivot axle, and the release mechanism is steadily connected between the retractable tube set and the coupling without occupying any internal space of the actuator body and with no need to change the specification of the external apparatus. When an emergency condition occurs, the retractable tube set can be manually operated to shorten the length, lowering the external apparatus. This design of release mechanism not only simplifies the overall structure and the difficulty of mold making, but also facilitates the alignment of the assembly work, effectively saving the assembly labor and cost and achieving the effects of easy assembly and stable structure.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a release mechanism incorporated linear actuator in accordance with the present invention.

FIG. 2 is an exploded view of the release mechanism incorporated linear actuator in accordance with the present invention.

FIG. 3 corresponds to FIG. 2 when viewed from another angle.

FIG. 4 is an exploded view of the release mechanism.

FIG. 5 corresponds to FIG. 4 when viewed from another angle.

FIG. 6 is a sectional side view of the release mechanism incorporated linear actuator in accordance with the present invention.

FIG. 7 is a sectional elevation of a part of the release mechanism incorporated linear actuator in accordance with the present invention.

FIG. 8 illustrates the outer appearance of the release mechanism before actuation.

FIG. 9 is a sectional view of the release mechanism before actuation.

FIG. 10 corresponds to FIG. 9, illustrating the release mechanism operated.

FIG. 11 is s schematic sectional side view of the present invention, illustrating the retractable tube set retracted.

FIG. 12 is an exploded view of a release mechanism for linear actuator according to the prior art.

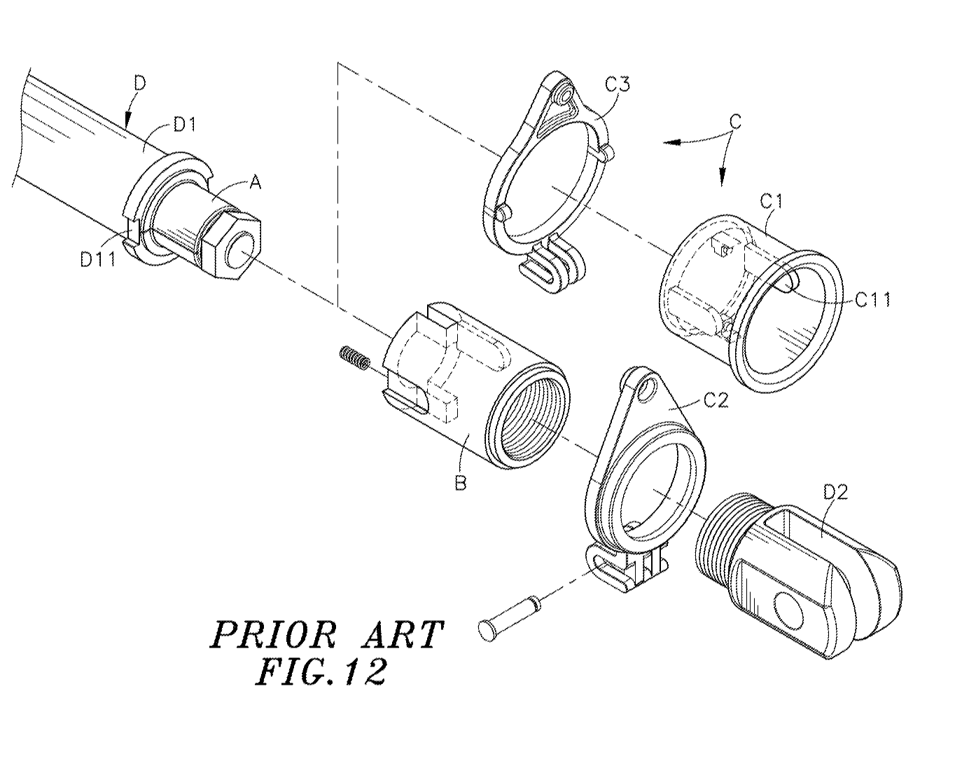

### DETAILED DESCRIPTION OF THE PREFERRED EMBODIMENT

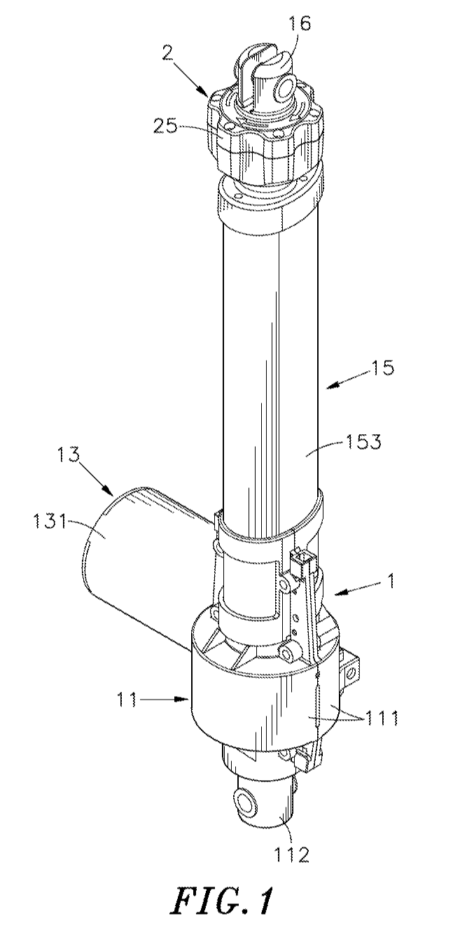

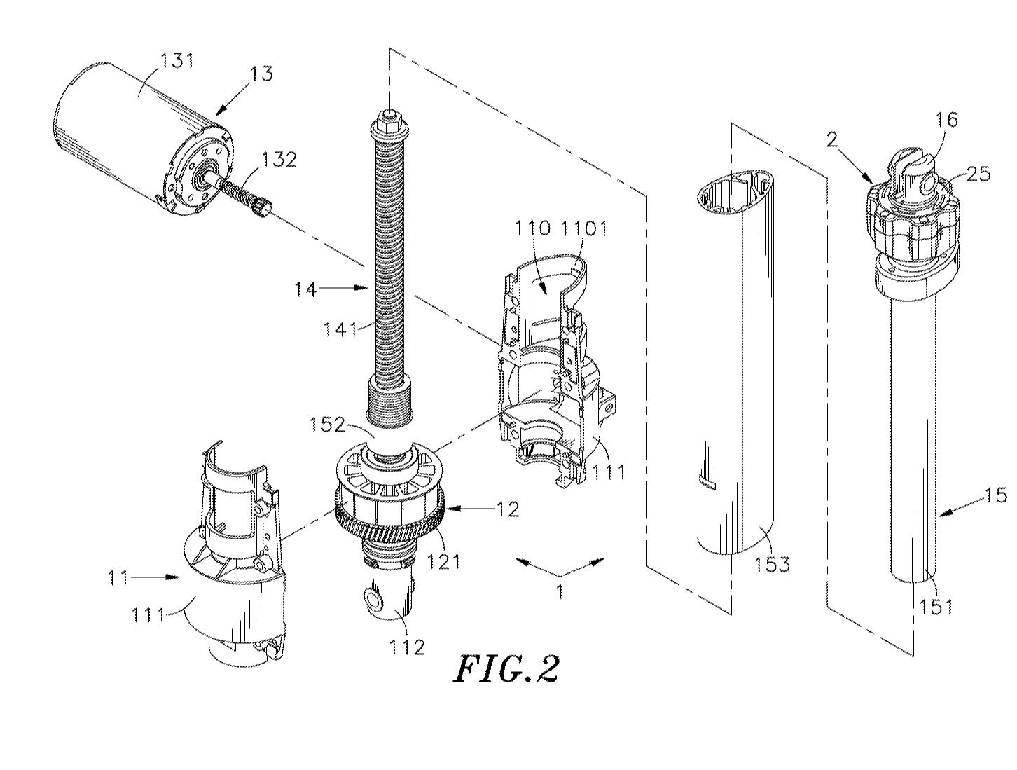

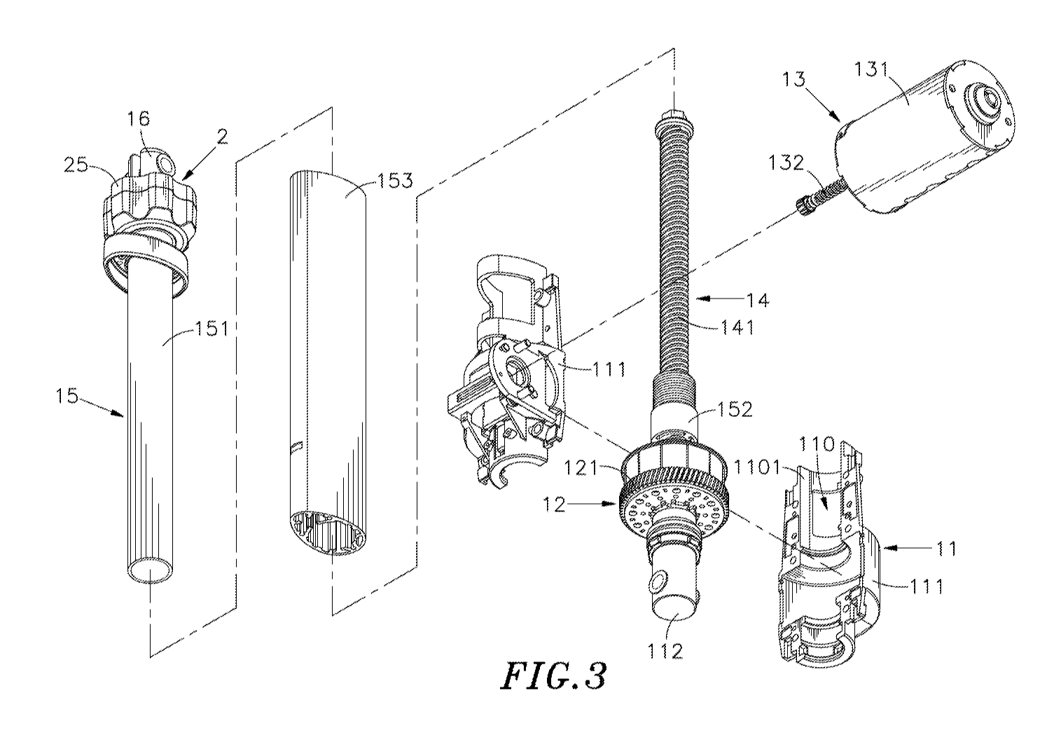

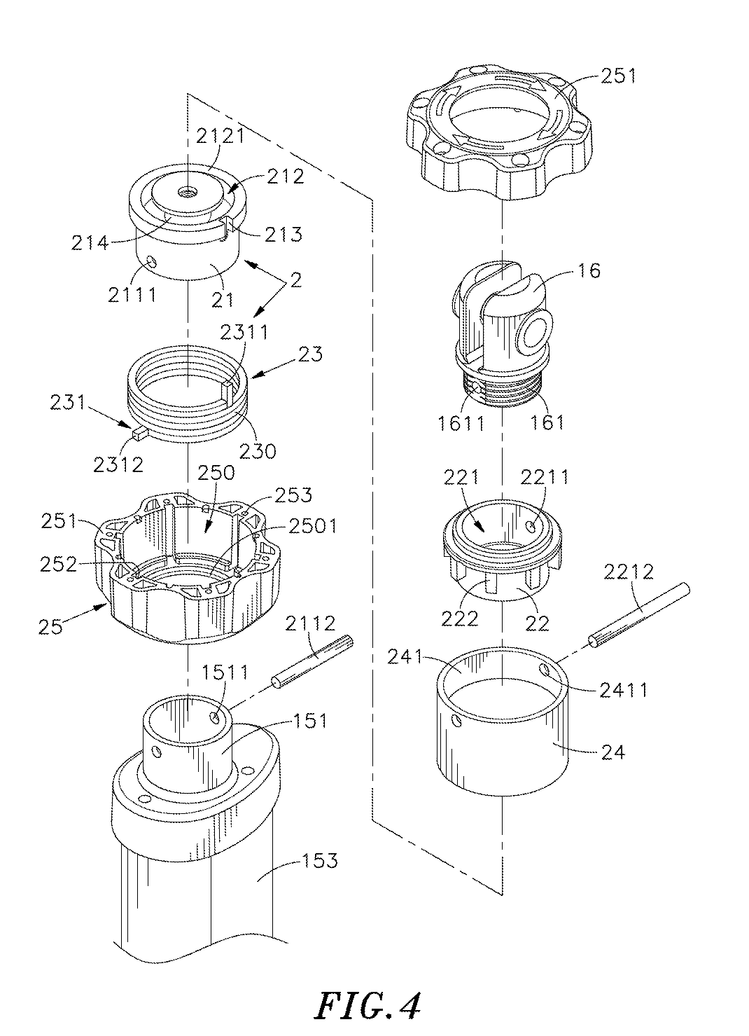

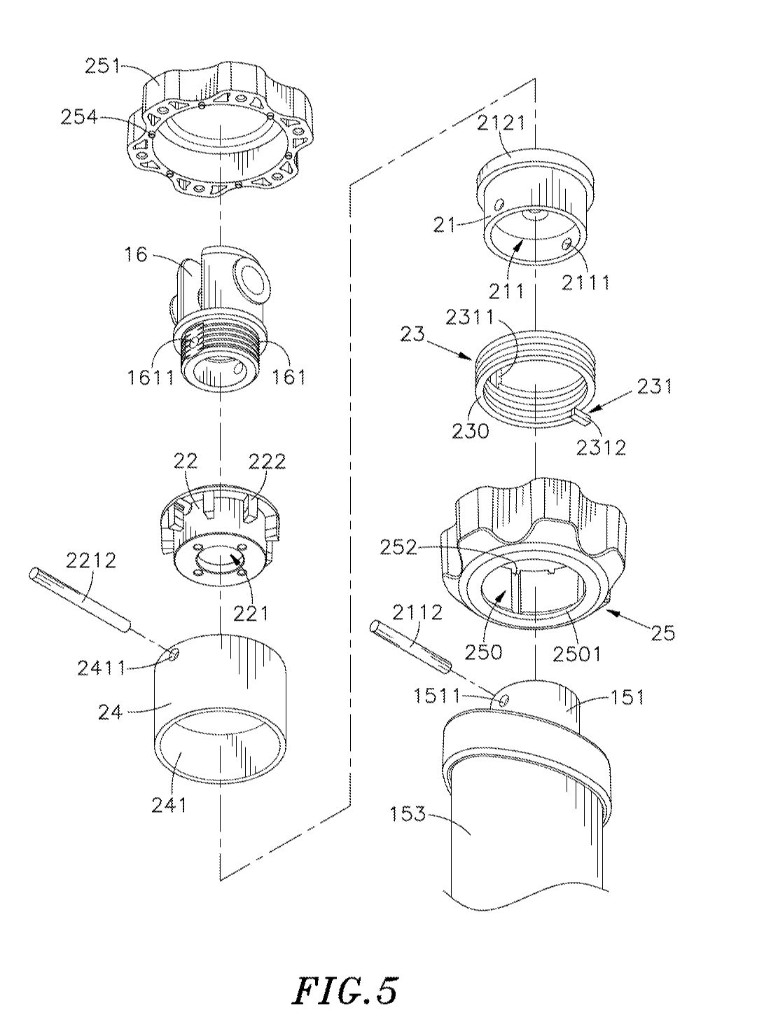

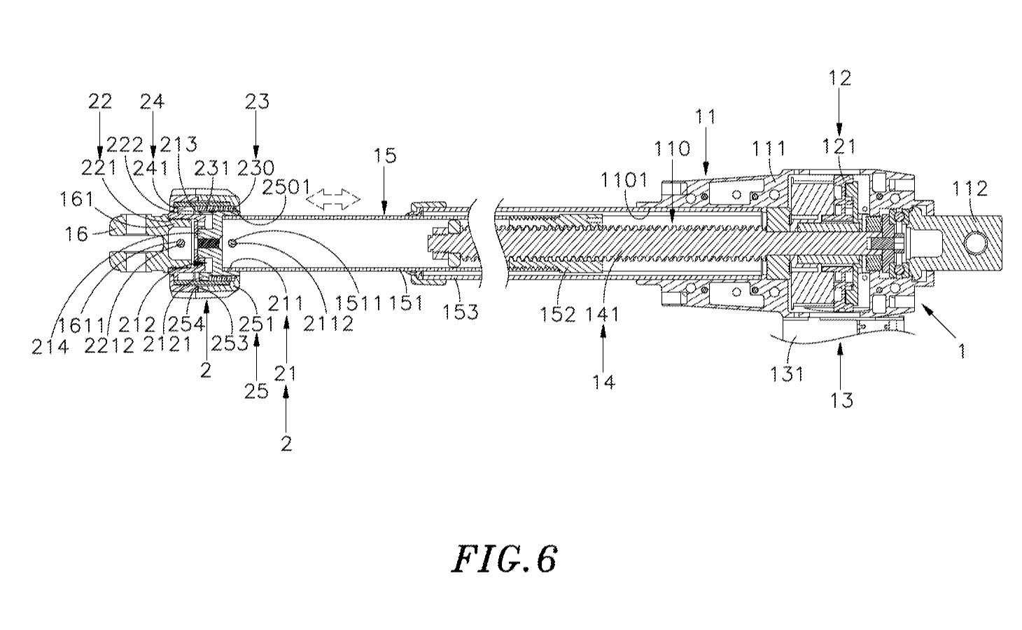

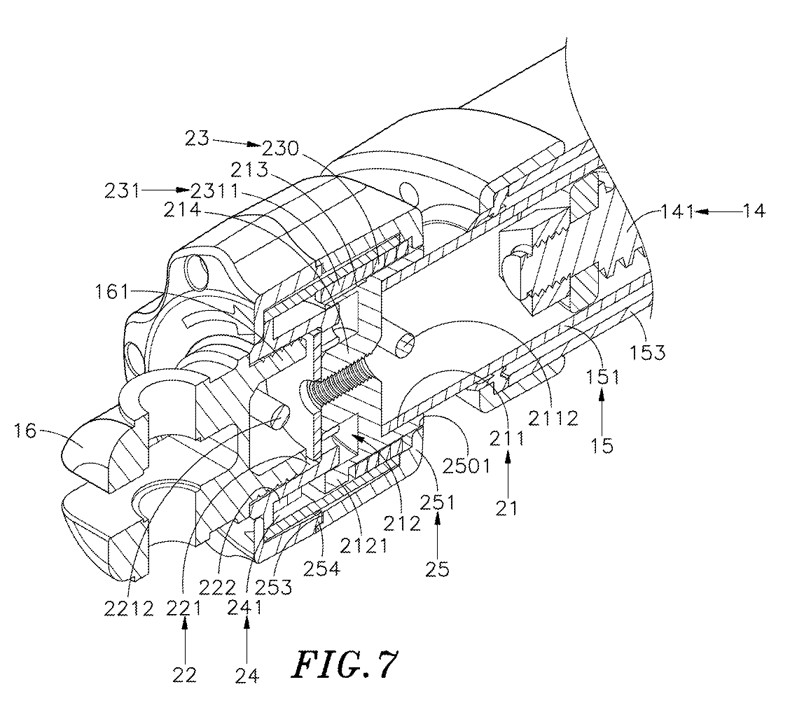

Referring to FIGS. 1-7, an oblique top elevational view of a release mechanism incorporated linear actuator in accordance with the present invention, an exploded view of the release mechanism incorporated linear actuator, another exploded view of the release mechanism incorporated linear actuator, an exploded view of the release mechanism, a sectional side view of the release mechanism incorporated linear actuator and a sectional elevation of a part of the release mechanism incorporated linear actuator are shown. As illustrated, the release mechanism incorporated linear actuator comprises an actuator body 1 and a release mechanism 2

The actuator body 1 comprises a holder block 11 consisting of two symmetrical annular shells 111 and defining therein an accommodation chamber 110 and an opening 1101 in each of opposing top and bottom sides thereof in communication with the accommodation chamber 110, a connection rod 112 fastened to the two annular shells 111 and extended out of the opening 1101 in the bottom side of the holder block 11, a gear set 12 mounted in the accommodation chamber 110 and comprising at least one drive gear (for example, worm gear) 121, and a power drive 13 comprising a motor 131 mounted to the holder block 11 on the outside and a driving shaft (for example, worm) 132 inserted into the inside of the holder block 11 and meshed with the drive gear 121 of the gear set 12 to rotate the gear set 12.

The actuator body 1 comprises a transmission mechanism 14, a retractable tube set 15 and a coupling 16. The transmission mechanism 14 comprises a lead screw 141 disposed perpendicular to or in parallel to the motor 131. The bottom end of the lead screw 141 is through the drive gear 121. The retractable tube set 15 is linearly retractably coupled to an opposing top end of the lead screw 141 outside the holder block 11, comprising an outer tube 153 fixedly connected to the holder block 11, a retractable inner tube 151 axially movable in and out of the outer tube 153, and a sliding nut 152 threaded onto the lead screw 141 and connected to an inner end of the retractable inner tube 151. The coupling 16 is connected to an opposing outer end of the retractable inner tube 151, and axially movable with the retractable inner tube 151 relative to the lead screw 141, for connecting with an external device. The actuator body 1 can be variously embodied. Modifications can be made to the actuator body without departing from the spirit and scope of the invention.

The release mechanism 2 is coupled between the retractable inner tube 151 of the retractable tube set 15 and a coupling head 161 of the coupling 16, comprising an adapter socket 21, a locating socket 22, a brake spring 23, a tightening sleeve 24 and a rotary knob 25. The adapter socket 21 comprises an adapter hole 211 axially defined in one end thereof and attached onto the retractable inner tube 151, a first pin hole 2111 transversely cut through the periphery thereof in communication with the adapter hole 211, a first pin 2112 mounted in the first pin hole 2111 and transversely inserted through a first through hole 1511 of the retractable inner tube 151 to secure the adapter socket 21 to the retractable inner tube 151, a coupling hole 212 axially defined in an opposite end of the adapter hole 211 thereof and movably coupled to the locating socket 22, an outer flange 2121 extended around the coupling hole 212 comprises a first engagement groove 213, and a pillar 214 located in a center of the coupling hole 212.

The locating socket 22 comprises a locating hole 221 axially defined in one end thereof opposite to the adapter socket 21 and coupled to the coupling head 161 of the coupling 16, a second pin hole 2211 transversely cut through the periphery thereof in communication with the locating hole 221, a second pin 2212 mounted in the second pin hole 2211 and inserted through a second through hole 1611 of the coupling head 161 to secure the locating socket 22 to the coupling head 161, and a plurality of stop blocks 222 equiangularly spaced around the periphery of the locating hole 221.

The brake spring 23 comprises a continuous series of elastic ring portions 230 mounted onto the periphery of the adapter socket 21, and positioning means 231 that comprises a first end piece 2311 and a second end piece 2312 respectively extended from the two opposite ends of the continuous series of elastic ring portions 230 in different directions.

The tightening sleeve 24 is made of metal or plastic steel and mounted around the locating socket 22 and the brake spring 23, comprising an inner sleeve surface 241 that is disposed in friction engagement with the brake spring 23 and a through hole 2411 transversely cut through the inner sleeve surface 241. The aforesaid second pin 2212 is inserted through the second pin hole 2211 of the locating socket 22 and the second through hole 1611 of the coupling head 161 with the two opposite ends thereof fastened to the through hole 2411 of the tightening sleeve 24 to secure the locating socket 22, the coupling 16 and the tightening sleeve 24 together.

The rotary knob 25 is attached onto the tightening sleeve 24, comprising two annular shells 251 fastened together, an insertion space 250 surrounded by the two annular shells 251, two mounting holes 2501 respectively defined in the two annular shells 251 in communication with opposing top and bottom sides of the insertion space 250 and respectively movably coupled to the adapter socket 21 and the locating socket 22, a plurality of positioning holes 253 equiangularly disposed in a top side of one annular shell 251, a diameter of the mounting hole 2501 is smaller than an inner diameter of the annular shell 251, a plurality of positioning rods 254 equiangularly disposed in a bottom side of the other annular shell 251 and respectively fastened to the positioning holes 253, and a plurality of second engagement grooves 252 axially disposed in insertion space 250. Further, the two annular shells 251 can be fastened together using screws.

In this embodiment, the adapter hole 211 of the adapter socket 21 is attached onto the retractable inner tube 151 of the retractable tube set 15, and then the adapter socket 21 and the retractable tube set 15 are fastened together by the first pin 2112; the locating hole 221 of the locating socket 22 is attached onto the coupling 16, and then the locating socket 22 and the coupling 16 are fastened together by the second pin 2212. These mounting procedures ae not a limitation. Key and keyway joint, screw joint, welding technique and other mounting techniques can be selectively employed to achieve the connection between the adapter socket 21 and the retractable tube set 15 and the connection between the locating socket 22 and the coupling 16.

In this embodiment, the first end piece 2311 of the positioning means 231 of the brake spring 23 is positioned in the first engagement groove 213 of the adapter socket 21, and the second end piece 2312 of the positioning means 231 of the brake spring 23 is extended out of the bottom side of the tightening sleeve 24 and positioned in one second engagement groove 252 of the rotary knob 25. Before inserting the brake spring 23 into the tightening sleeve 24, the outer diameter of the brake spring 23 is larger than the inner diameter of the inner sleeve surface 241. Therefore, when the second end piece 2312 of the positioning means 231 of the brake spring 23 is turned in clockwise direction, the elastic ring portions 230 are tightened up to reduce the diameter for insertion into the tightening sleeve 24 and attachment onto the adapter socket 21. Thus, when the applied force is released from the brake spring 23, the elastic restoring energy of the brake spring 23 immediately forces the brake spring 23 into friction engagement with the inner sleeve surface 241 of the tightening sleeve 24.

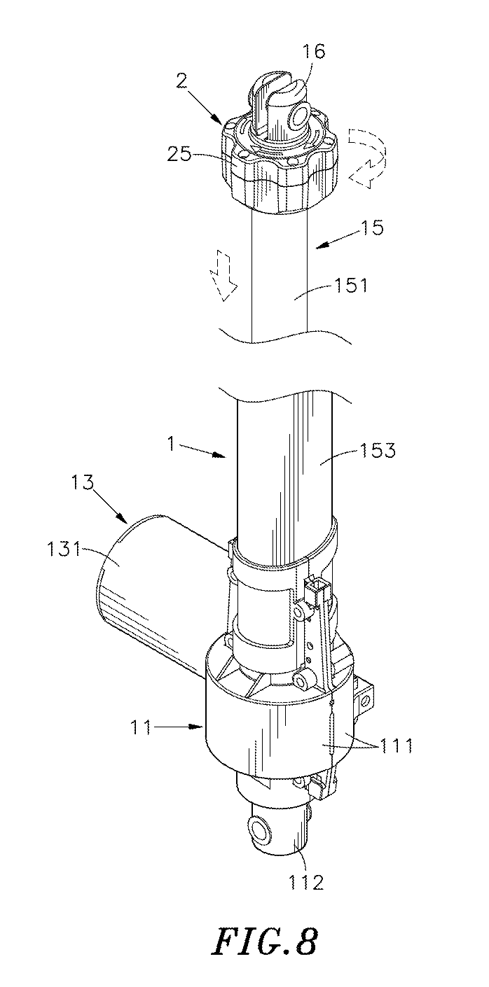

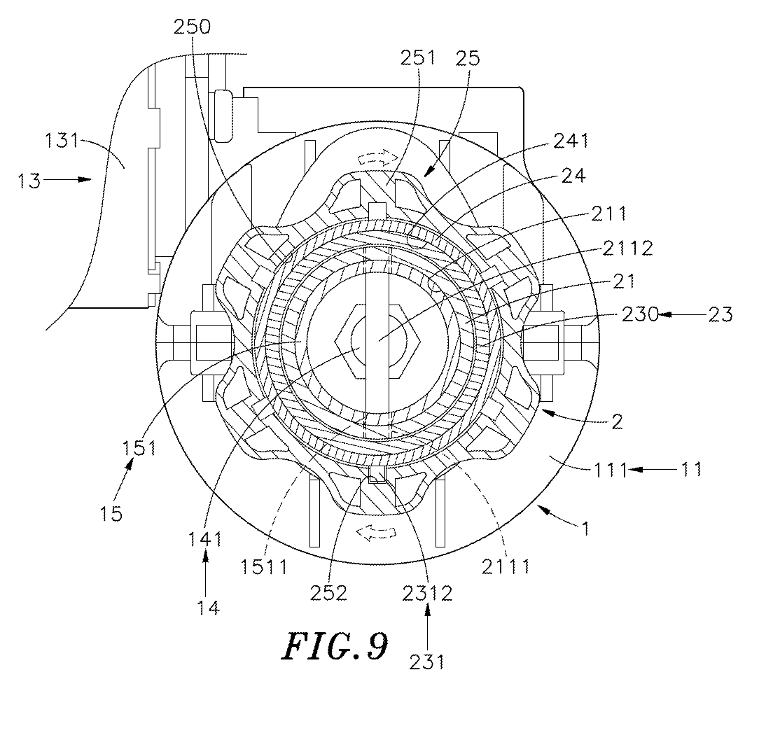

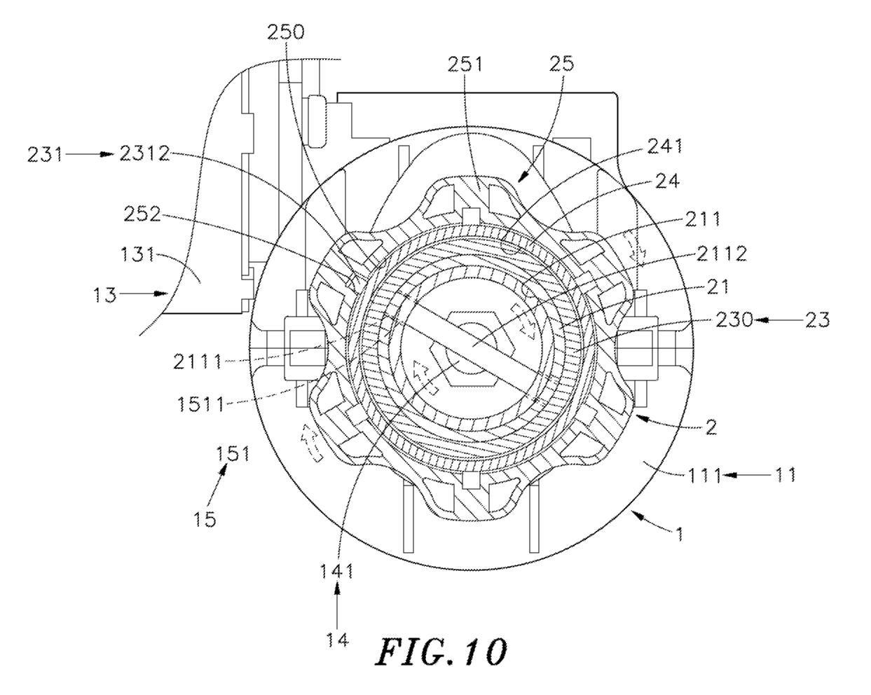

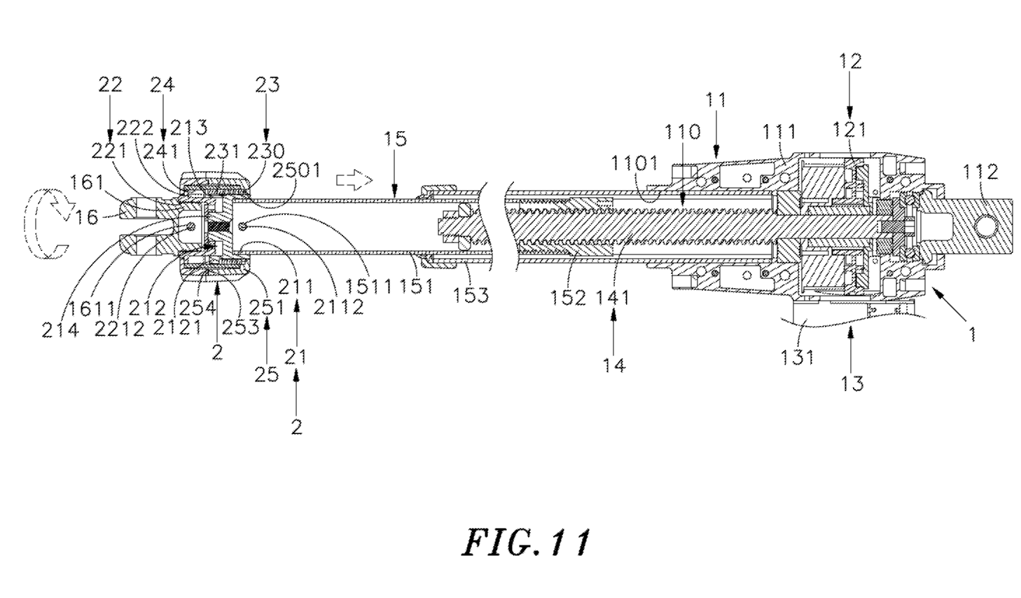

Referring to FIGS. 8-11, an elevational view of the release mechanism before operation, a sectional top view of the release mechanism, a sectional top view of the retractable tube set and a sectional side view of the retractable tube set are shown. As illustrated, the actuator body 1 of the release mechanism incorporated linear actuator is installed in a link or bracket seat of an external apparatus (such as electric bed, massage chair, fitness or rehabilitation machine), lifter or any other equipment. The connection rod 112 of the holder block 11 and the coupling 16 are respectively pivotally connected to the link or bracket seat of the external apparatus by a screw bolt or pivot axle, and the release mechanism 2 steadily connected between the retractable tube set 15 and the coupling 16 without occupying any internal space of the actuator body 1 and with no need to change the specification of the external apparatus or to make a mold of a different specification. The invention can also be used in an existing or commercial actuator of any other design, saving the costs.

After installation, the brake spring 23 of the release mechanism 2 is kept in friction engagement with the inner sleeve surface 241 of the tightening sleeve 24 with one of the positioning means 231 positioned in the first engagement groove 213 of the adapter socket 21. When the motor 131 of the power drive 13 drives the driving shaft 132 to rotate the gear set 12, the gear set 12 drives the lead screw 141 of the transmission mechanism 14 to move the sliding nut 152 of the retractable tube set 15, forcing the retractable inner tube 151 and the adapter socket 21 against the positioning means 231 of the brake spring 23, and thus, the elastic ring portions 230 are extended out to abut against the inner sleeve surface 241 of the tightening sleeve 24, prohibiting the retractable inner tube 151 and the adapter socket 21 from rotation. At this time, the sliding nut 152 is moved along the lead screw 141, causing linear movement of the retractable inner tube 151 relative to the holder block 11 to extend or shorten the length of the linear actuator, and the coupling 16 is forced to lift the link or bracket seat of the external apparatus, achieving elevational or angular adjustment.

In operation, rotate the annular shells 251 of the rotary knob 25 clockwise to force the second engagement groove 252 of the rotary knob 25 against the second end piece 2312 of the positioning means 231 of the brake spring 23 in clockwise direction, tightening the elastic ring portion 230 to wrap about the adapter socket 21 and releasing friction engagement between the elastic ring portions 230 and the inner sleeve surface 241 of the tightening sleeve 24. At this time, the adapter socket 21 is released from the constraint of the tightening sleeve 24. Therefore, when the external apparatus is pushed backwards (for instance, downwards) against the coupling 16 under the influence of self-weight or external force, the locating socket 22 can be pushed against the adapter socket 21 to move the retractable inner tube 151 and the sliding nut 152 along the lead screw 141 in shortening the length of the retractable tube set 15. Thus, the retractable tube set 15 is manually operable to shorten the length upon power failure or mechanical failure, enhancing operational safety. This design of release mechanism 2 not only simplifies the overall structure and the difficulty of mold making, but also facilitates the alignment of the assembly work, effectively saving the assembly labor and cost and achieving the effects of easy assembly and stable structure.

As described above, the release mechanism 2 is coupled between the retractable tube set 15 and coupling 16 of the actuator body 1; the locating socket 22 is movably coupled to the adapter socket 21; the brake spring 23 is mounted around the periphery of the adapter socket 21; the tightening sleeve 24 is attached onto the locating socket 22 and the brake spring 23; the rotary knob 25 is attached onto the tightening sleeve 24; the brake spring 23 is peripherally disposed in friction engagement with the inner sleeve surface 241 of the tightening sleeve 24; when the user operates the rotary knob 25 to move the brake spring 23, the brake spring 23 is forced to reduce its diameter and to wrap about the adapter socket 21, causing disengagement between the brake spring 23 and the tightening sleeve 24, allowing manual operation of the retractable tube set 15 upon power failure or mechanical failure and enhancing operational safety.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A release mechanism incorporated linear actuator, comprising:
an actuator body comprising a holder block, a gear set mounted in said holder block, a power drive adapted for rotating said gear set, a transmission mechanism, comprising a lead screw meshed with said gear set, a retractable tube set linearly retractably coupled to said lead screw outside said holder block and a coupling connected to an outer end of said retractable inner tube outside said holder block and axially movable with said retractable inner tube relative to said lead screw; and
a release mechanism coupled between said retractable tube set and said coupling, said release mechanism comprising an adapter socket connected to said retractable tube set, a locating socket connected to said coupling and movable coupled to said adapter socket, a brake spring mounted around said adapter socket, said brake spring comprising positioning means, a tightening sleeve connected to said locating socket and attached onto said locating socket and said brake spring and a rotary knob attached onto said tightening sleeve, said positioning means of said brake spring comprising a first end piece and a second end piece respectively extended from two opposite end thereof in different directions, said first end piece being positioned in said adapter, said second end piece being extended out of said tightening sleeve and positioned in said rotary knob, said brake spring being peripherally disposed in friction engagement with an inner surface of said tightening sleeve; and
wherein when rotating said rotary knob to move said second end piece of said positioning means of said brake spring in one direction, said brake spring is forced to reduce the diameter thereof and to wrap about said adapter socket, releasing friction engagement between said brake spring and said tightening sleeve.

2. The release mechanism incorporated linear actuator as claimed in claim 1, wherein said power drive comprises a motor mounted to said holder block, and a driving shaft inserted into said holder block and meshed with said gear set.

3. The release mechanism incorporated linear actuator as claimed in claim 1, wherein said retractable tube set of said actuator body comprises an outer tube fixedly connected to said holder block, a retractable inner tube axially movable in and out of said outer tube, and a sliding nut affixed to an inner end of said retractable inner tube and threaded onto said lead screw.

4. The release mechanism incorporated linear actuator as claimed in claim 3, wherein said adapter socket of said release mechanism comprises an adapter hole axially defined in one end thereof and attached onto said retractable inner tube, and a coupling hole axially defined in an opposite end thereof and movably coupled to said locating socket.

5. The release mechanism incorporated linear actuator as claimed in claim 4, wherein said adapter socket further comprises an outer flange extended around said coupling hole, and a first engagement groove located at said outer flange for the positioning of said first end piece of said positioning means of said brake spring.

6. The release mechanism incorporated linear actuator as claimed in claim 3, wherein said locating socket of said release mechanism comprises a locating hole axially defined in one end thereof opposite to said adapter socket and coupled to said coupling; said tightening sleeve is attached onto said locating socket, defining therein an inner sleeve surface for friction engagement with said brake spring.

7. The release mechanism incorporated linear actuator as claimed in claim 1, wherein said brake spring of said release mechanism further comprises a continuous series of elastic ring portions; said first end piece and said second end piece of said positioning means are respectively extended from two opposite ends of said continuous series of elastic ring portions in different directions.

8. The release mechanism incorporated linear actuator as claimed in claim 1, wherein an outer diameter of said brake spring of said release mechanism is larger than an inner diameter of said tightening sleeve.

9. The release mechanism incorporated linear actuator as claimed in claim 1, wherein said rotary knob of said release mechanism comprises two annular shells fastened together, an insertion space surrounded by said two annular shells, and two mounting holes respectively defined in said two annular shells in communication with opposing top and bottom sides of said insertion space and respectively movably coupled to said adapter socket and said locating socket, diameters of said mounting holes are smaller than diameters of said annular shells.

10. The release mechanism incorporated linear actuator as claimed in claim 9, wherein said rotary knob further comprises a second engagement groove defined in said insertion space for the positioning of said second end piece of said positioning means of said brake spring.
